(19) United States
(12) Patent Application Publication
(10) Pub. No.: US 2008/0245954 A1
(43) Pub. Date: Oct. 9, 2008

(54) Color sensitive device with temperature compensation and variable gain and display system using the same

(75) Inventor: Meng-Kun Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/730,728

(22) Filed: Apr. 3, 2007

(51) Int. Cl. H01J 40/14

(52) U.S. Cl. 250/214 R

(57) ABSTRACT

A color sensitive device with temperature compensation and variable gain is disclosed. The color sensitive device exposed by RGB light can generate red-light, green-light and blue-light detection currents corresponding to the illumination of RGB light via a P-N interface of RGB photodiodes. The red-light, green-light and blue-light detection currents are transformed into voltage signals, which can be magnified via a variable resistor external to the color sensitive device. In addition, the color sensitive device includes a temperature compensation circuit for adjusting the non-ideal characteristics of photodiodes, so that a color display system using the color sensitive device will has excellent white balance after receiving the RGB voltage signals.

### BACKGROUND OF THE INVENTION

1. Field of the Invention

The present invention relates to a color sensitive device with temperature compensation and variable gain and a display system using the same, particularly relates to a color sensitive device capable of processing subtraction operation of current for temperature compensation and of outputting voltage gain via manual variable resistor.

2. Background of the Invention

Conventional color sensor generates optical detection current by the photodiode accepting illumination, and a built-in circuit transforms the optical detection current into a voltage signal. Then the voltage signal is magnified for adapting for a system. However, one disadvantage of the photodiode is the range of the optical detection current varies a lot in accordance with light strength and environment temperature. Thus, due to the environment temperature, the voltage signal from the conventional color sensor doesn't match the light strength completely.

In another aspect, conventional red (R), green (G) and blue (B) sensors are constructed in a limited IC cavity, a diode with R, G and B linear signals corresponding to variable illumination is produced by R, G, B coating. The conventional sensor still results in shortcomings as below:
1. The silicon, which the diode is made of, has different responses to R, G, B lights, so that a post system accepting the responses of R, G, B lights is hard to meet the ideal white balance point.
2. The diode is hugely sensitive to temperature, so as to produce an unstable and inaccurate voltage signal.

Obviously, although the conventional storage device provides static information through various types of displays and provides status thereof through LEDs, the real time information about action state or access speed cannot demonstrate immediately. Hence, an improvement over the prior art is required to overcome the disadvantages thereof.

### SUMMARY OF THE INVENTION

The object of the invention is therefore to specify a color sensitive device with temperature compensation and variable gain. The color sensitive device exposed by RGB light can generate red-light, green-light and blue-light detection currents corresponding to the illumination of RGB light via a P-N interface of RGB photodiodes. The red-light, green-light and blue-light detection currents are transformed into voltage signals, which can be magnified via a variable resistor external to the color sensitive device. In addition, the color sensitive device includes a temperature compensation circuit for adjusting the non-ideal characteristics of photodiodes, so that a color display system using the color sensitive device will be arrived excellent white balance point status after receiving the RGB voltage signals.

According to the invention, the object is achieved to provide a color sensitive device with temperature compensation and variable gain, which includes a temperature sensor, a current amplifier, a red sensor, a first current differential amplifier, a first variable resistor, a green sensor, a second current differential amplifier, a second variable resistor, a blue sensor, a third current differential amplifier, and a third variable resistor. The temperature sensor outputs the current reference signal. The current amplifier couples with the temperature sensor for receiving and magnifying the current reference signal. The red sensor outputs the red-light detection current. The first current differential amplifier couples with the red sensor and the current amplifier. The red-light detection current and the current reference signal are processed by subtraction operation via the first current differential amplifier, so that the first current differential amplifier outputs the first outputs current. The first variable resistor couples to the first current differential amplifier, the first variable resistor receives the first outputs current and generating the red-light voltage signal. The green sensor outputs the green-light detection current. The second current differential amplifier couples with the green sensor and the current amplifier. The green-light detection current and the current reference signal are processed by subtraction operation via the second current differential amplifier, so that the second current differential amplifier outputs the second outputs current. The second variable resistor couples to the second current differential amplifier, the second variable resistor receives the second outputs current and generating the green-light voltage signal. The blue sensor outputs the blue-light detection current. The third current differential amplifier couples with the blue sensor and the current amplifier. The blue-light detection current and the current reference signal are processed by subtraction operation via the third current differential amplifier, so that the third current differential amplifier outputs the third outputs current. The third variable resistor couples to the third current differential amplifier, the third variable resistor receives the third outputs current and generating the blue-light voltage signal.

According to the invention, the object is achieved to further provide a display system using the color sensitive device with temperature compensation and variable gain. The display system includes a panel for demonstration; a light emission unit providing illumination for the panel; a color sensitive device detecting illumination strength and outputting a voltage signal corresponding to the illumination strength; a controller coupling with the color sensitive device receiving the voltage signal and outputting a control signal; and a driver coupling to the controller and the light emission unit. The driver receives the control signal and outputs a driving voltage so as to drive the light emission unit.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a circuit diagram of a first embodiment of a color sensitive device with temperature compensation and variable gain according to the present invention;

FIG. 2 is a circuit diagram concerning to a current differential amplifier and a current amplifier according to the color sensitive device of the present invention;

FIG. 3 is a circuit diagram of a second embodiment of the color sensitive device according to the present invention; and

FIG. 4 is a drawing diagram according to a display system using the color sensitive device of the present invention.

### DETAILED DESCRIPTION OF THE PREFERRED EMBODIMENTS

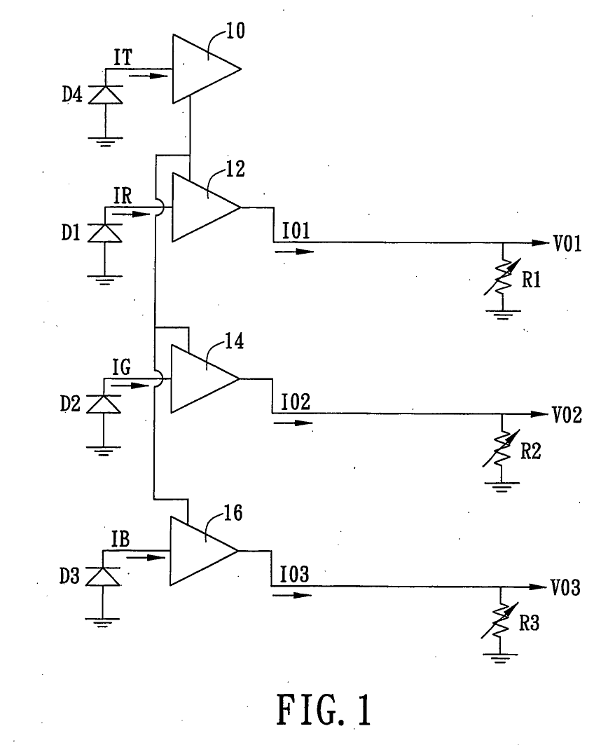

Referring to FIG. 1, a circuit diagram according to a first embodiment of a color sensitive device 1 with temperature compensation and variable gain according to the present invention is illustrated. The color sensitive device 1 includes a temperature sensor D4 coupling with a current amplifier 10, a red sensor D1 outputting a red-light detection current, the first current differential amplifier 12 coupling with the red sensor D1 and the current amplifier 10, and a first variable resistor R1 coupling to the first current differential amplifier 12. The temperature sensor D4 is a dummy diode for detecting environment temperature and outputting a current reference signal IT corresponding to the environment temperature. The current amplifier 10 receives and magnifies the current reference signal IT. The red sensor D1 is a photodiode for sensing red light and generating a red-light detection current IR. The red-light detection current IR and the current reference signal IT are processed by subtraction operation via the first current differential amplifier 12, so that the first current differential amplifier 12 outputs a first outputting current I01. The first variable resistor R1 receives the first outputting current I01 and generates a red-light voltage signal V01.

The color sensitive device 1 further includes a green sensor D2, a second current differential amplifier 14 coupling with the green sensor D2 and the current amplifier 10, and a second variable resistor R2 coupling to the second current differential amplifier 14. The green sensor D2 is a photodiode for sensing green light and generating a green-light detection current IG The green-light detection current IG and the current reference signal IT are processed by subtraction operation via the second current differential amplifier 14, so that the second current differential amplifier 14 outputs a second outputting current I02. The second variable resistor R2 receives the second outputting current I02 and generates a green-light voltage signal V02.

The color sensitive device 1 further includes a blue sensor D3, a third current differential amplifier 16 coupling with the blue sensor D3 and the current amplifier 10, and a third variable resistor R3 coupling to the third current differential amplifier 16. The blue sensor D3 is a photodiode for sensing blue light and generating a blue-light detection current IB. The blue-light detection current IB and the current reference signal IT are processed by subtraction operation via the third current differential amplifier 16, so that the third current differential amplifier 16 outputs a third outputting current I03. The third variable resistor R3 receives the third outputting current I03 and generates a blue-light voltage signal V03.

The temperature sensor D4, the current amplifier 10, the red sensor D1, the first current differential amplifier 12, the green sensor D2, the second current differential amplifier 14, the blue sensor D3, and the third current differential amplifier 16 are packaged as a integral circuit. Furthermore, the first variable resistor R1, the second variable resistor R2 or the third variable resistor R3 is a manual variable resistor.

The color sensitive device according to the present invention exposed under illumination with various RGB lights generates optical detection currents IR, IG, IB via photodiodes D1-D3 receiving RGB lights respectively. Due to the photodiodes D1-D3 are effective to environment temperature easily, each optical detection current IR, IG, or IB has a small error value ΔT according to changes of environment temperature. The current reference signal IT generated from the current amplifier 10 and processed via the current amplifier 10 varies corresponding to the changes of environment temperature in a linear response. Therefore, the subtraction operation is disclosed in the color sensitive device according to the present invention so as to correct the small error value ΔT. For detail descriptions, the first current differential amplifier 12, the second current differential amplifier 14 and the third current differential amplifier 16 receives minor optical detection currents IR, IG, IB respectively. The minor optical detection currents IR, IG, IB are further compared with the current reference signal IT by subtraction operation via the first, the second and the third current differential amplifiers 12, 14 and 16 one on one. The subtraction operation is used to eliminate the small error value ΔT in the optical detection currents IR, IG, IB, and further to correct the non-ideal outcome to environment temperature.

After the subtraction operation, the first current differential amplifier 12, the second current differential amplifier 14 and the third current differential amplifier 16 further provide amplification operation onto the processed optical detection currents IR, IG, IB and output the outputting currents I01, I02 and I03. The “external” variable resistors R1, R2 and R3 transform the outputting currents I01, I02 and I03 into the optical voltage signals V01, V02 and V03, respectively. The “external” variable resistors R1, R2 and R3 also adjust the gain values of the optical voltage signals V01, V02 and V03, respectively. Thus, the optical voltage signals V01, V02 and V03 provided by the color sensitive device for a display system is relative to the real values of RGB lights of illumination.

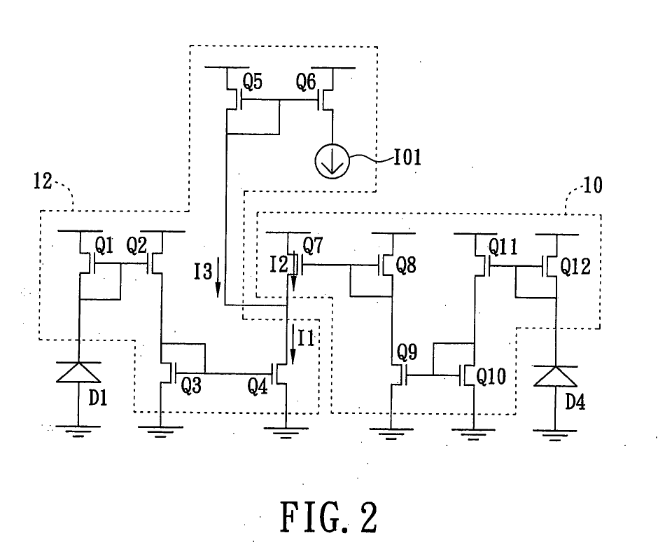

Illustrated in FIG. 2, a circuit diagram concerning to the current differential amplifier and the current amplifier is disclosed. Taking the photodiode D1 as an example, the current differential amplifier 12 has a current mirror including internal transistors Q1-Q4, which magnify discerned optical detection current detected by the photodiode D1 into current I1. In another aspect, the current amplifier 10 magnifies discerned optical detection current detected by the temperature sensor D4 into current I2 via internal transistors Q7-Q12. The current differential amplifier 12 obtains the current I2 from a transistor Q7 of the current amplifier 10 and the current I1, so as to process the currents I1 and I2 by subtraction operation for getting the current I3. The current I3 is magnified to outputting current I01 by passing the current mirror composed of internal transistors Q5-Q6 in the current differential amplifier 12.

As a conclusion, the transistors Q4, Q5, Q7 are provided for subtraction operation of the current.

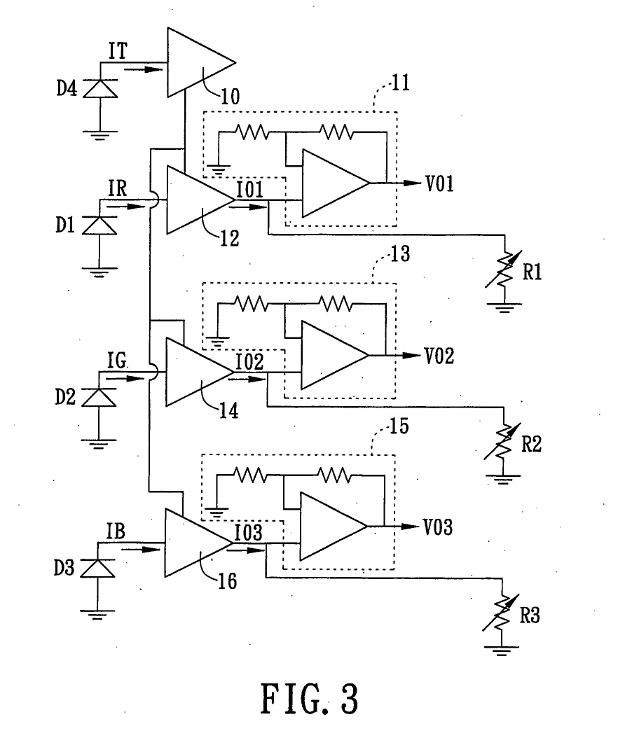

Illustrated in FIG. 3, a circuit diagram of a second embodiment of the color sensitive device is disclosed. Elements in the second embodiment are the same as those in the first embodiment, and referenced by similar symbols. Moreover, the circuit actions and achieved effects of the second embodiment are the same as those of the first embodiment.

In comparison with the first embodiment, the color sensitive device 1a in the second embodiment further includes a first voltage amplifier 11, a second voltage amplifier 13 and a third voltage amplifier 15. The first voltage amplifier 11 couples with the first variable resistor R1. The first voltage amplifier 11 magnifies the red-light voltage signal. The second voltage amplifier 13 couples with the second variable resistor R2. The second voltage amplifier 13 magnifies the green-light voltage signal. The third voltage amplifier 15 couples with the third variable resistor R3. The third voltage amplifier 15 magnifies the blue-light voltage signal.

Referring to FIG. 3, a circuit diagram of a second embodiment of the color sensitive device is illustrated. The temperature sensor D4, the current amplifier 10, the red sensor D1, the first current differential amplifier I2, the green sensor D2, the second current differential amplifier I4, the blue sensor D3, the third current differential amplifier 16, the first voltage amplifier 11, the second voltage amplifier 13 and the third voltage amplifier 15 are packaged an integral circuit.

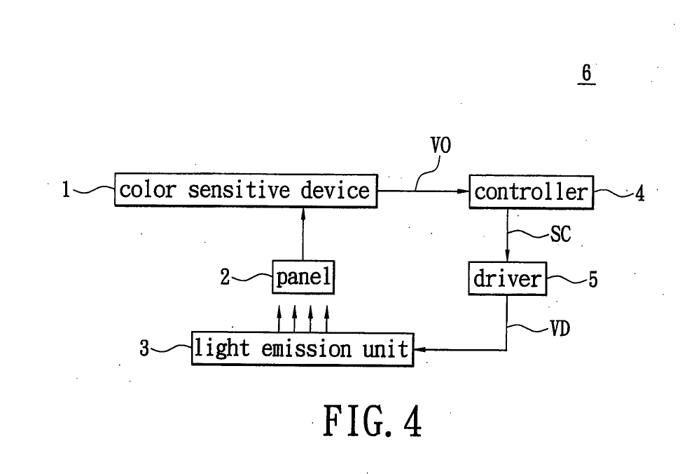

Referring to FIG. 4, a drawing diagram according to a display system using the color sensitive device is illustrated. The display system 6 includes a panel 2 for demonstration, a light emission unit 3 providing illumination for the panel 2, the color sensitive device 1 detecting illumination strength and outputting a voltage signal VO corresponding to the illumination strength, a controller 4 coupling with the color sensitive device 1 receiving the voltage signal VO and outputting a control signal SC, and a driver 5 coupling to the controller 4 and the light emission unit 3. The driver 5 receives the control signal SC and outputs a driving voltage VD so as to drive the light emission unit 3.

According to the present invention, the color sensitive device 1 or 1a has advantages of:

1. The internal signals of the integral circuit control gain of a voltage signal corresponding to color strength via external resistors, so that the RGB primary color signals are variable signals for applying for different color display system;

2. The photocurrent non-linear effected by environment temperature can be corrected by temperature compensation, so that the error due to temperature can be eliminated; and

3. The amplifying circuit inside the integral circuit can output variable voltage signals corresponding to various light strength, and provide outputting RGB saturation voltages relative to the voltage signals.

According to the present invention, RGB outputting current of RGB sensors can correspond to real distribution of illumination for achieving RBG connections and avoiding color shifts. In addition, temperature compensation is provided to eliminate the effects resulted from temperature, so that the precise proportions of RGB lights will be obtained for real practice.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A color sensitive device with temperature compensation and variable gain, comprising:
a temperature sensor outputting an analog current reference signal;
a current amplifier coupling with the temperature sensor, the current amplifier receiving and magnifying the analog current reference signal;
a red sensor outputting a red-light analog detection current;
a first current differential amplifier coupling with the red sensor and the current amplifier, wherein the red-light analog detection current and the analog current reference signal are processed by subtraction operation via the first current differential amplifier so that the first current differential amplifier outputs a first analog output current;
a first variable resistor coupling to the first current differential amplifier, the first variable resistor receiving the first output analog current and generating a red-light voltage signal;
a green sensor outputting a green-light analog detection current;
a second current differential amplifier coupling with the green sensor and the current amplifier, wherein the green-light analog detection current and the analog current reference signal are processed by subtraction operation via the second current differential amplifier, so that the second current differential amplifier outputs a second analog output current;
a second variable resistor coupling to the second current differential amplifier, the second variable resistor receiving the second analog output current and generating a green-light voltage signal;
a blue sensor outputting a blue-light analog detection current;
a third current differential amplifier coupling with the blue sensor and the current amplifier, wherein the blue-light analog detection current and the analog current reference signal are processed by subtraction operation via the third current differential amplifier, so that the third current differential amplifier outputs a third analog output current; and
a third variable resistor coupling to the third current differential amplifier, the third variable resistor receiving the third analog output current and generating a blue-light voltage signal.

2. The color sensitive device with temperature compensation and variable gain as claimed in claim 1, further including a first voltage amplifier coupling with the first variable resistor, wherein the first voltage amplifier magnify the red-light voltage signal.

3. The color sensitive device with temperature compensation and variable gain as claimed in claim 1, further including a second voltage amplifier coupling with the second variable resistor, wherein the second voltage amplifier magnify the green-light voltage signal.

4. The color sensitive device with temperature compensation and variable gain as claimed in claim 1, further including a third voltage amplifier coupling with the third variable resistor, wherein the third voltage amplifier magnify the blue-light voltage signal.

5. The color sensitive device with temperature compensation and variable gain as claimed in claim 1, wherein the temperature sensor is a dummy diode.

6. The color sensitive device with temperature compensation and variable gain as claimed in claim 1, wherein the red sensor, the green sensor or the blue sensor is a light diode.

7. The color sensitive device with temperature compensation and variable gain as claimed in claim 1, wherein the temperature sensor, the current amplifier, the red sensor, the first current differential amplifier, the green sensor, the second current differential amplifier, the blue sensor, and the third current differential amplifier are packaged as an integral circuit.

8. the color sensitive device with temperature compensation and variable gain as claimed in claim 7, wherein the integral circuit further includes a first voltage amplifier coupling with the first current differential amplifier, a second voltage amplifier coupling with the second current differential amplifier, and a third voltage amplifier coupling with the third current differential amplifier.

9. The color sensitive device with temperature compensation and variable gain as claimed in claim 1, wherein the first variable resistor, the second variable resistor or the third variable resistor is a manual variable resistor.

10. A display system using the color sensitive device with temperature compensation and variable gain as claimed in claim 1, the display system comprising:
a panel for demonstration;
a light emission unit providing illumination for the panel;
a color sensitive device detecting illumination strength and outputting an analog voltage signal corresponding to the illumination strength;
a controller coupling with the color sensitive device receiving the analog voltage signal and outputting an analog control signal; and
a driver coupling to the controller and the light emission unit;
wherein the driver receives the analog control signal and outputs a driving voltage so as to drive the light emission unit.

11. A color sensitive device with temperature compensation and variable gain, comprising
a light sensor generating an analog optical detection current;
a temperature sensor outputting an analog current reference signal;
a current differential amplifier coupling with the light sensor and temperature sensor, wherein the analog optical detection current and the analog current reference signal are processed by subtraction operation via the current differential amplifier, so that the current differential amplifier outputs an analog outputting current; and
a variable resistor coupling to the current differential amplifier, the variable resistor receiving the analog output current and generating a voltage signal.

12. The color sensitive device with temperature compensation and variable gain as claimed in claim 11, further including a voltage amplifier coupling with the variable resistor, wherein the voltage amplifier magnify the voltage signal.

13. The color sensitive device with temperature compensation and variable gain as claimed in claim 11, wherein the temperature sensor is a dummy sensor.

14. The color sensitive device with temperature compensation and variable gain as claimed in claim 11, wherein the light sensor is a light diode.

15. The color sensitive device with temperature compensation and variable gain as claimed in claim 11, wherein the light sensor, the temperature sensor, and the current differential amplifier are packaged as an integral circuit.

16. The color sensitive device with temperature compensation and variable gain as claimed in claim 15, wherein the integral circuit further includes a voltage amplifier coupling with the current differential amplifier.

17. The color sensitive device with temperature compensation and variable gain as claimed in claim 11, wherein the variable resistor is a manual variable resistor.
